(19) United States
(12) Patent Application Publication
(10) Pub. No.: US 2026/0057354 A1
(43) Pub. Date: Feb. 26, 2026

(54) SYSTEMS AND METHODS FOR GENERATING AND SAVING STORE RECEIPTS TO ONLINE ACCOUNTS

(71) Applicant: Walmart Apollo, LLC, Bentonville, AR (US)

(72) Inventors: Aman Srivastava, Sunnyvale, CA (US); Mary Michele James, Danville, CA (US); Michael David Desilva, Tacoma, WA (US); Hailey McCall Nelson, Playa Del Rey, CA (US); Nithin Ashok, San Jose, CA (US); Mohammad Zahed Hossain, Union City, CA (US); Soubhik Biswas, Bangalore, Karnataka (IN)

(21) Appl. No.: 18/813,162

(22) Filed: Aug. 23, 2024

(51) Int. Cl. G06Q 20/38; G06Q 20/32; G06Q 30/0203

(52) U.S. Cl. CPC G06Q 20/047; G06Q 20/322; G06Q 20/389; G06Q 30/0203

(57) ABSTRACT

Systems and methods for generating and saving an in-store receipt to an online account are disclosed. In some embodiments, a disclosed method includes: receiving, from a computing device, a request for a payment receipt associated with a transaction of a user at a physical store of a retailer; transmitting an electronic message to a user device of the user based on the request, wherein the electronic message includes a link to the payment receipt; identifying an online account of the user associated with the retailer, in accordance with a determination that the user has clicked on the link; and adding the transaction as part of a purchase history associated with the online account based on the payment receipt.

### TECHNICAL FIELD

This application relates generally to payment receipt generation and, more particularly, to systems and methods for generating a payment receipt for an in-store transaction of a user and saving the payment receipt to an online account of the user.

### BACKGROUND

In a variety of transactions, consumers or buyers of goods or services typically receive receipts from their respective merchants or service providers as proof of existence of conducted transactions. Generally, receipts are issued by merchants and service providers for a number of reasons including, for example, regulatory or tax reasons and convenience purposes. A receipt provides information about a corresponding transaction for the purpose of providing all participants with a trace or record of the transaction. Receipts can later be used by a consumer for various purposes including, for example, proving participation in a transaction for tax reporting purpose, product returns, use as a claim ticket for a further transaction, provisioning warranties, etc. Depending on a variety of factors, such as, for example, items being purchased, business or personal purchase, amount of purchase, etc., a consumer may desire an electronic receipt and/or a paper receipt.

For in-store purchases, consumers generally obtain a paper receipt at the point-of-sale. However, some point-of-sale systems (cashier-based or self-checkout-based) also support the delivery of electronic or digital receipts at the point-of-sale. In addition, when a customer performs online purchases, electronic receipts are typically delivered to the customer based on the customer's online account information. While a retailer may have both physical stores and an online retail platform (i.e. e-commerce platform), there is no existing method to associate together receipts of a same customer for transactions performed both in-store and online, which misses a great opportunity for the retailer to provide online functionalities and/or promotions to an in-store customer.

### SUMMARY

The embodiments described herein are directed to systems and methods for generating a payment receipt for an in-store transaction of a user and saving the payment receipt to an online account of the user.

In various embodiments, a system including a non-transitory memory configured to store instructions thereon and at least one processor is disclosed. The at least one processor is operatively coupled to the non-transitory memory and configured to read the instructions to: receive, from a computing device, a request for a payment receipt associated with a transaction of a user at a physical store of a retailer; transmit an electronic message to a user device of the user based on the request, wherein the electronic message includes a link to the payment receipt; identify an online account of the user associated with the retailer, in accordance with a determination that the user has clicked on the link; and add the transaction as part of a purchase history associated with the online account based on the payment receipt.

In various embodiments, a computer-implemented method is disclosed. The computer-implemented method includes: receiving, from a computing device, a request for a payment receipt associated with a transaction of a user at a physical store of a retailer; transmitting an electronic message to a user device of the user based on the request, wherein the electronic message includes a link to the payment receipt; identifying an online account of the user associated with the retailer, in accordance with a determination that the user has clicked on the link; and adding the transaction as part of a purchase history associated with the online account based on the payment receipt.

In various embodiments, a non-transitory computer readable medium having instructions stored thereon is disclosed. The instructions, when executed by at least one processor, cause at least one device to perform operations including: receiving, from a computing device, a request for a payment receipt associated with a transaction of a user at a physical store of a retailer; transmitting an electronic message to a user device of the user based on the request, wherein the electronic message includes a link to the payment receipt; identifying an online account of the user associated with the retailer, in accordance with a determination that the user has clicked on the link; and adding the transaction as part of a purchase history associated with the online account based on the payment receipt.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for generating and saving an in-store receipt to an online account, in accordance with some embodiments of the present teaching;

FIG. 2 is a block diagram of an order details computing device, in accordance with some embodiments of the present teaching;

FIG. 3 is a block diagram illustrating various portions of a system for generating and saving an in-store receipt to an online account, in accordance with some embodiments of the present teaching;

FIG. 4 illustrates an exemplary process for generating and saving an in-store receipt to an online account, in accordance with some embodiments of the present teaching;

FIG. 5 illustrates an exemplary user device receiving a link to a payment receipt, in accordance with some embodiments of the present teaching;

FIG. 6 illustrates various exemplary order details pages in different scenarios, in accordance with some embodiments of the present teaching;

FIG. 7 illustrates various exemplary headers in an order details page, in accordance with some embodiments of the present teaching;

FIG. 8 illustrates an exemplary exit pass section in an order details page, in accordance with some embodiments of the present teaching;

FIG. 9 illustrates an exemplary survey section in an order details page, in accordance with some embodiments of the present teaching;

FIG. 10A illustrates an exemplary payment receipt section in an order details page, in accordance with some embodiments of the present teaching;

FIG. 10B illustrates an exemplary item list subsection of a receipt section in an order details page, in accordance with some embodiments of the present teaching;

FIG. 11 illustrates various exemplary return sections in an order details page, in accordance with some embodiments of the present teaching;

FIG. 12 illustrates various exemplary log-in sections in an order details page, in accordance with some embodiments of the present teaching;

FIG. 13 illustrates an exemplary user promotion section in an order details page, in accordance with some embodiments of the present teaching;

FIG. 14 shows a flowchart illustrating an exemplary method for generating and saving an in-store receipt to an online account, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

An online retail customer typically has an online account associated with a retailer, such that information related to all purchases performed online by the customer may be automatically saved as a purchase history of the online account. While many in-store customers lose their paper receipts from time to time, it would be easier for these customers if they can receive an electronic receipt for their in-store purchases, especially when the electronic receipt is saved in a database, e.g. attached to their online accounts.

One objective of various embodiments in the present teaching is to develop systems and methods for generating a payment receipt for an in-store transaction of a user and saving the payment receipt electronically in association with an online account of the user with minimal disruption.

In some examples, a customer uses self-checkout service in a physical store of a retailer, after adding all items at the self-checkout. After a payment is complete, the customer can have the payment receipt printed out and/or sent to a user device of the customer via a text message or email. For example, if the customer selects sending the payment receipt via a text message, a window is prompted up for the customer to enter a phone number to receive the text message including a link to view the payment receipt electronically online. The payment receipt generated electronically for the in-store customer is more than a raw HyperText Markup Language (HTML) based receipt or a scanned copy or of a paper receipt, which cannot be saved to an online account or interacted by the customer.

In some embodiments, the payment receipt generated electronically for the in-store customer has a format consistent with formats of online transactions performed by the customer using the online account of the customer. With one click on the link by the customer, the payment receipt can be added to a purchase history associated with the online account, and an order details page is directly open to show order details of the customer's in-store purchase based on the payment receipt. As such, the online account of the customer is now associated with a purchase history including transactions performed by the customer both in-store and online.

In addition, the customer can then perform online actions regarding the in-store transaction. According to some embodiments, the customer can start a return for one or more items of the in-store transaction as if the in-store transaction was instead performed online, to make use of online functionalities with different features related to item return. According to some embodiments, the customer can reorder anything in the previous in-store transaction from an online webpage. For example, by clicking an auto-add button for an item of the in-store transaction, the customer can directly add that item to cart and place an order from the item without going to the store again.

In some embodiments, when the user clicks on the link in the text message, the system can detect whether an application associated with the retailer is installed on the user device of the customer. If the application is installed, the system will open the application based on the link to show an order details page including information of the receipt and directly save the receipt into an online account of the customer. If the application is not installed, the system will open a web browser on the user device to direct to a website of the retailer via the link, to show an order details page including information of the receipt. If the customer is authenticated or has already logged into an online account, the system directly save the receipt into the online account, via a mobile web experience or deep web experience depending on a device type of the user device. If the customer is unauthenticated or has not logged in, the system shows the information of the receipt to the customer regarding the in-store purchase, and also provides an option for the customer to sign in, to add the receipt to the online account, permanently or at least for many years.

In some embodiments, the order details page displayed to the customer via the link include all the information regarding the in-store transaction, e.g. the transaction date and time, the items, the price, the amount, the payment method, etc. In addition, the order details page can include one or more additional content sections. In some examples, the order details page includes an exit pass section including a barcode to be scanned by an associate at the physical store to verify whether items on the payment receipt match items exiting the physical store with the user. In some examples, the order details page includes a survey section including a survey about an experience of the customer at the physical store. For example, the survey may be a star rating survey or a net promoter score (NPS) survey, for understanding the customer's experience. In some examples, the order details page includes a return section including a return option for the customer to initiate a return process associated with the transaction. In some examples, the customer can view, download, or print out the in-store receipt from the order details page, where the in-store receipt may be shown in any applicable document format.

In some embodiments, the order details page can include different content items or sections based on a time period from when the in-store transaction is complete to when the link is clicked on. For example, when the time period is shorter than a first time period threshold (e.g. 2 or 4 hours), the order details page includes: information of the payment receipt in an expanded manner; the exit pass section; and the survey section. When the time period is longer than the first time period threshold but shorter than a second time period threshold (e.g. 24 hours), the order details page includes: information of the payment receipt in a collapsed manner; the survey section; and the return section. When the time period is longer than the second time period threshold, the order details page includes: information of the payment receipt in a collapsed manner; and the return section.

As such, the disclosed systems and methods provide customers a one-click solution to save an in-store receipt to an online account, as well as performing all kinds of possible online actions in the receipt itself or related to the in-store transaction.

Furthermore, in the following, various embodiments are described with respect to systems and methods for generating and saving an in-store receipt to an online account are disclosed. In some embodiments, a disclosed method includes: receiving, from a computing device, a request for a payment receipt associated with a transaction of a user at a physical store of a retailer; transmitting an electronic message to a user device of the user based on the request, wherein the electronic message includes a link to the payment receipt; identifying an online account of the user associated with the retailer, in accordance with a determination that the user has clicked on the link; and adding the transaction as part of a purchase history associated with the online account based on the payment receipt.

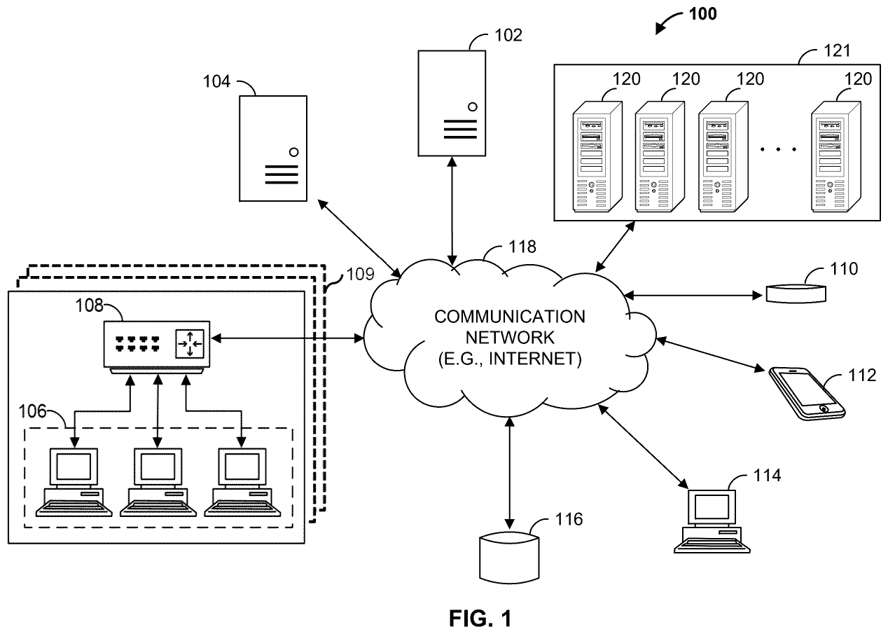

Turning to the drawings, FIG. 1 is a network environment 100 configured for generating and saving an in-store receipt to an online account, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an order details computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The order details computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the order details computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the order details computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the order details computing device 102, the processing devices 120, and/or the server 104 are operated by a retailer, and the multiple user computing devices 110, 112, 114 are operated by merchants, customers, associates, or managers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at one or more stores 109 of a retailer, for example. The workstation(s) 106 can communicate with the order details computing device 102 over the communication network 118. The workstation(s) 106 may send data to, and receive data from, the order details computing device 102. For example, the workstation(s) 106 may transmit a payment receipt or data identifying items purchased by a customer at the one or more stores 109 to the order details computing device 102. The workstation(s) 106 may also transmit other data related to the one or more stores 109 to the order details computing device 102.

Although FIG. 1 illustrates three user computing devices 110, 112, 114, the network environment 100 can include any number of user computing devices 110, 112, 114. Similarly, the network environment 100 can include any number of the order details computing devices 102, the processing devices 120, the workstations 106, the stores 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website, such as a retailer's website, hosted by the server 104. Similarly, each of the multiple user computing devices 110, 112, 114 may be operable to view, access, and interact with an application programming interface (API) hosted by the server 104.

In some examples, a store 109, e.g. using a workstation 106 related to checkout service, may transmit a receipt transmission request to the order details computing device 102, requesting a transmission of a payment receipt associated with a transaction of a user at a physical store of a retailer. The order details computing device 102 may then transmit an electronic message to a user device of the user based on the request, wherein the electronic message includes a link to the payment receipt. The payment receipt may be generated at the store 109 or at the order details computing device 102. In some embodiments, the order details computing device 102 may also forward the payment receipt to the server 104, which will then send the payment receipt to the user device. The electronic message may be an email or a text message.

In some examples, after the user clicks on the link, the server 104 transmits to the order details computing device 102 an order data request seeking order details related to the in-store transaction of the user. In some examples, the order details computing device 102 may execute one or more models (e.g., programs or algorithms), such as a machine learning model, deep learning model, statistical model, etc., to generate an order details page including information related to the in-store transaction as well as other order related data. The order details computing device 102 and/or the server 104 may identify an online account of the user associated with the retailer, and add the in-store transaction as part of a purchase history associated with the online account based on the payment receipt.

In some embodiments, the order details computing device 102 is further operable to communicate with the database 116 over the communication network 118. For example, the order details computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the order details computing device 102, in some examples, the database 116 can be a local storage device, such as a hard drive, a non-volatile memory, or a USB stick. For example, the order details computing device 102 may store online purchase data received from the server 104 in the database 116. The order details computing device 102 may receive in-store purchase data and store related data from the one or more stores 109 and store them in the database 116.

In some examples, the order details computing device 102 generates and/or updates different models (e.g., machine learning models, deep learning models, statistical models, algorithms, etc.) for generating and saving an in-store receipt to an online account. The order details computing device 102 may generate training data for the models based on data including but not limited to: historical receipt data, user account data, purchase history data, data related to customers, items and stores, etc. The order details computing device 102 trains the models based on their corresponding training data, and stores the models in a database, such as in the database 116 (e.g., a cloud storage). The models, when executed by the order details computing device 102, allow the order details computing device 102 to generate order related data for generating an order details page, to be shown to a user clicking on the link to the payment receipt.

In some examples, the order details computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the order details computing device 102 may generate order related data.

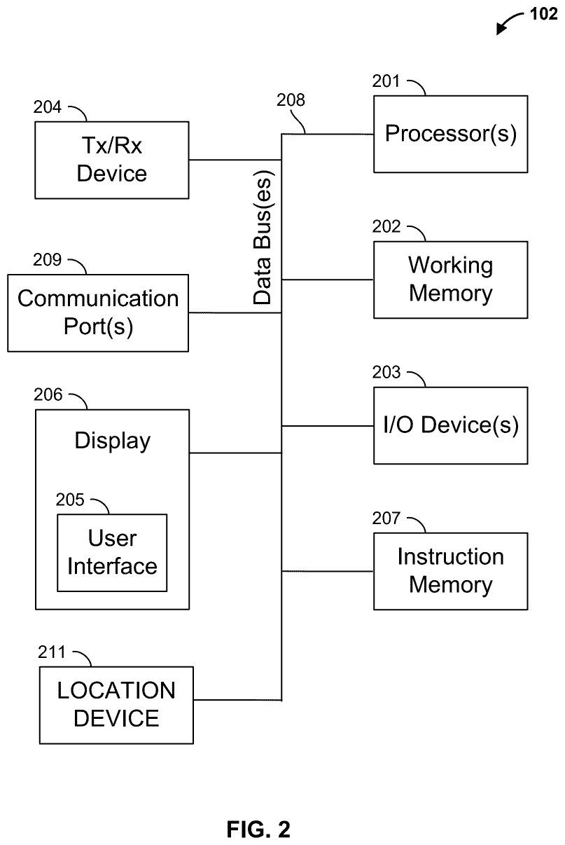

FIG. 2 illustrates a block diagram of an order details computing device, e.g. the order details computing device 102 of FIG. 1, in accordance with some embodiments of the present teaching. In some embodiments, each of the order details computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the order details computing device 102 can be combined, omitted, and/or replicated. In addition, it will be appreciated that additional elements other than those illustrated in FIG. 2 can be added to the order details computing device 102.

As shown in FIG. 2, the order details computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the order details computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the order details computing device 102 can include a single memory unit configured to operate as both instruction memory and working memory. Further, although embodiments are discussed herein including non-volatile memory, it will be appreciated that the order details computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the order details computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the order details computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the order details computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the order details computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the order details computing device 102 may determine a local geographical area (e.g., town, city, state, etc.) of its position.

In some embodiments, the order details computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

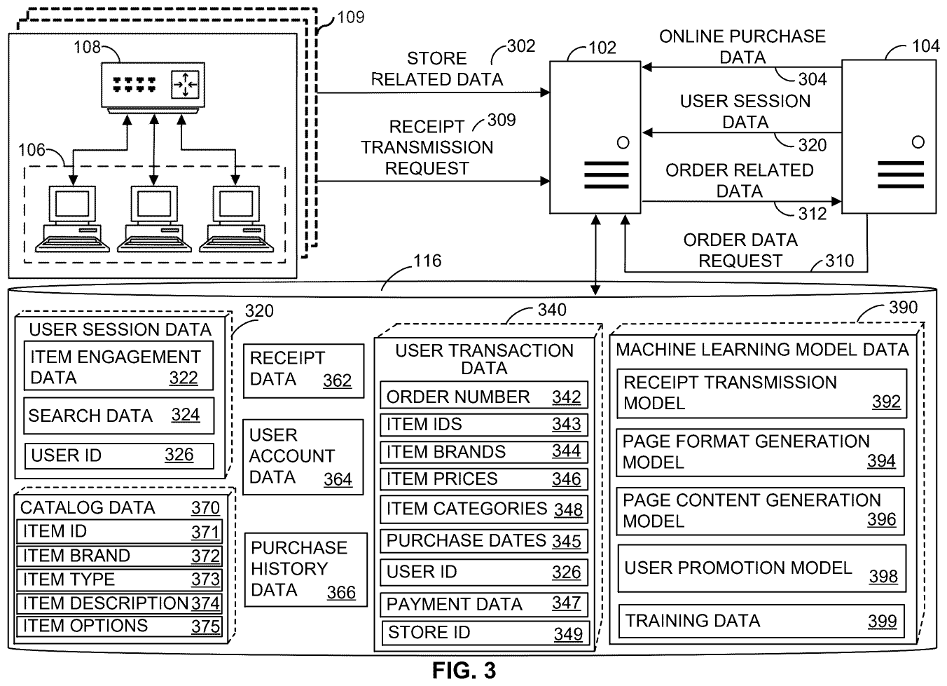

FIG. 3 is a block diagram illustrating various portions of a system for generating and saving an in-store receipt to an online account, e.g. the system shown in the network environment 100 of FIG. 1, in accordance with some embodiments of the present teaching. As indicated in FIG. 3, the order details computing device 102 may receive user session data 320 from the server 104, and store the user session data 320 in the database 116. The user session data 320 may identify, for each user (e.g., customer or manager), data related to that user's browsing session, such as when browsing a retailer's webpage or API hosted by the server 104.

In some examples, the user session data 320 may include item engagement data 322, search data 324, and user ID 326 (e.g., a customer ID, supplier ID, manager ID, retailer website login ID, a cookie ID, etc.). The item engagement data 322 may include one or more of a session ID (i.e., a website browsing session identifier), click data identifying data elements or items which a user clicked, data functions used by the user, advertisements viewed or clicked by the user during the browsing session, etc.

The order details computing device 102 may also receive online purchase data 304 from the server 104, which identifies and characterizes one or more online purchases, such as purchases made by the user and other users via a retailer's website hosted by the server 104. The order details computing device 102 may also receive store related data 302 from the one or more stores 109, which identifies and characterizes one or more in-store purchases. In some embodiments, the store related data 302 may also indicate other information about the one or more stores 109.

The order details computing device 102 may parse the store related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, user ID 326 for the user making the corresponding purchase, payment data 347 indicating payment methods and related information (e.g. emails associated with payment) for corresponding online orders, and store ID 349 for the corresponding in-store purchase, or for the pickup store or shipping—from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as item shelf, description, use or brand names, or any other suitable description), and item options 375 (e.g., item colors, sizes, flavors, etc.).

In some embodiments, the database 116 may further store receipt data 362, user account data 364, and purchase history data 366. The receipt data 362 may identify receipts created for the user transactions performed in the store(s) 109 and online via a website or application hosted by the server 104. The user account data 364 may identify online accounts of users of the website or application. The purchase history data 366 may identify a purchase history of each user associated with an online account, where the purchase history may include both in-store purchases and online purchases performed by the user.

The database 116 may also store machine learning model data 390 identifying and characterizing one or more models and related data for generating and saving an in-store receipt to an online account. For example, the machine learning model data 390 may include: a receipt transmission model 392, a page format generation model 394, a page content generation model 396, a user promotion model 398, and training data 399.

The receipt transmission model 392 in this example can be used to determine a transmission manner of a payment receipt to a user. The transmission manner may be determined based on a user selection during a checkout process of the user's transaction at a store 109 of the retailer. The transmission manner may include: a text message, an email, or any other electronic message. The payment receipt may be transmitted by the store 109, the order details computing device 102 or the server 104, via a link in the electronic message.

The page format generation model 394 in this example can be used to generate or determine a format for an order details page, when the order details page is displayed to a user who clicks on a link to a payment receipt in the electronic message on a user device. In some embodiments, the order details page can have different formats based on: a device type of the user device; an operating system of the user device; and/or software used to open the link on the user device.

The page content generation model 396 in this example can be used to generate or determine content items and sections to be included in an order details page, when the order details page is displayed to a user who clicks on a link to a payment receipt in the electronic message on a user device. In some embodiments, the order details page can have different content items based on: a time period from when the transaction is complete to when the link is clicked on; a first time period threshold; and a second time period threshold longer than the first time period threshold.

In some examples, when the time period is shorter than a first time period threshold (e.g. 2 or 4 hours), the order details page includes: information of the payment receipt in an expanded manner; an exit pass section including a barcode to be scanned by an associate at the physical store to verify whether items on the payment receipt match items exiting the physical store with the user; and a survey section including a survey about an experience of the user at the physical store. When the time period is longer than the first time period threshold but shorter than a second time period threshold (e.g. 24 hours), the order details page includes: information of the payment receipt in a collapsed manner; the survey section; and a return section including a return option for the user to initiate a return process associated with the transaction. When the time period is longer than the second time period threshold, the order details page includes: information of the payment receipt in a collapsed manner; and the return section.

The user promotion model 398 in this example can be used to generate one or more user promotions to be included in an order details page, when the order details page is displayed to a user who clicks on a link to a payment receipt in the electronic message on a user device. The one or more user promotions may include: an advertisement about an item and/or a discounted price, a retailer membership activation code, an account creation option, etc.

In some embodiments, one or more of the receipt transmission model 392, the page format generation model 394, the page content generation model 396, and the user promotion model 398 can be implemented as a machine learning model. The training data 399 may include data utilized for training one or more of the receipt transmission model 392, the page format generation model 394, the page content generation model 396 and the user promotion model 398. In some examples, the training data 399 may be formed based on: actual sales data of some items at stores during a past time period, synthetic sales data generated based on the actual sales data, user account data, user session data, etc.

In some examples, the training data 399 is updated based on updated sales data and/or user interactions with the store, the website or the app. In some embodiments, the machine learning model data 390 includes any number of the receipt transmission model(s) 392, the page format generation model(s) 394, the page content generation model(s) 396, and the user promotion model(s) 398.

In some examples, the order details computing device 102 receives a receipt transmission request 309 from a store 109. The receipt transmission request 309 may be triggered by at least one of: a self-checkout process of a user regarding a transaction at a physical store of a retailer; or a scanning (e.g. using an application associated with the retailer) of a paper copy of a payment receipt regarding the transaction. The order details computing device 102 may transmit an electronic message to a user device of the user based on the receipt transmission request 309, by itself or via the server 104. The electronic message includes a link to the payment receipt. After the user clicks on the link on the user device, the server 104 may transmit an order data request 310 to the order details computing device 102. The order data request 310 may seek order related data 312 regarding the in-store transaction of the user based on the payment receipt.

In some embodiments, the order details computing device 102 or the server 104 may identify an online account of the user associated with the retailer, in accordance with a determination that the user has clicked on the link, and add the transaction as part of a purchase history associated with the online account based on the payment receipt. In response to the order data request 310, the order details computing device 102 transmits the order related data 312 to the server 104. The order related data 312 may be used to generate an order details page to be shown to the user, where the order details page comprises information of the payment receipt and at least one of: an exit pass section including a barcode to be scanned by an associate at the physical store to verify whether items on the payment receipt match items exiting the physical store with the user; a survey section including a survey about an experience of the user at the physical store; or a return section including a return option for the user to initiate a return process associated with the transaction.

In some embodiments, the order details computing device 102 may assign one or more of the above described operations to a different processing unit or virtual machine hosted by one or more processing devices 120. Further, the order details computing device 102 may obtain the outputs of the these assigned operations from the processing units, and generate the order related data 312 based on the outputs.

In some embodiments, the order details computing device 102 may automatically update the order related data 312. For example, based on a configuration, an update request, or a predetermined periodic time interval, the order details computing device 102 can collect updated relevant features and run one or more of the models in the machine learning model data 390 again to generate updated order related data.

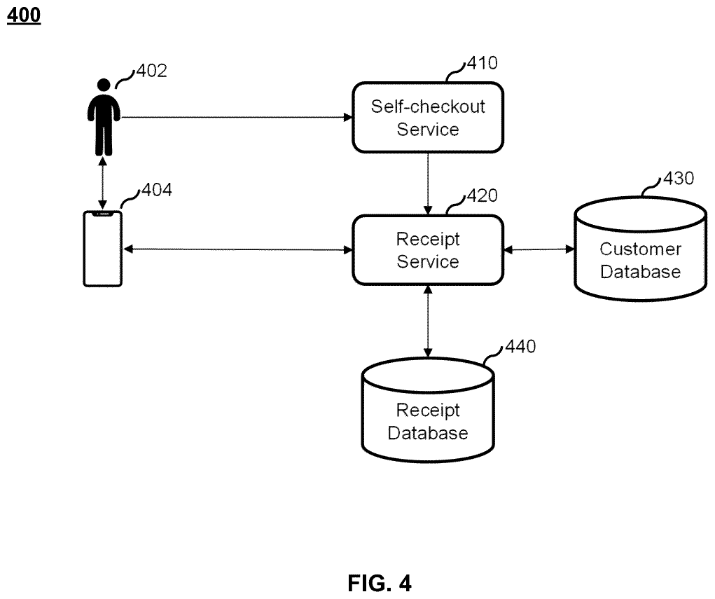

FIG. 4 illustrates an exemplary process 400 for generating and saving an in-store receipt to an online account, in accordance with some embodiments of the present teaching. In some embodiments, the process 400 can be carried out by one or more computing devices, such as the order details computing device 102, the server 104, the cloud-based engine 121 and/or one of the user computing devices 110, 112, 114 of FIG. 1.

As shown in FIG. 4, the process 400 starts from a user 402 performing a self-checkout process at a self-checkout service 410, e.g. in a physical store of a retailer. A similar process can be applied to other checkout services, e.g. cashier-based checkout, cloud-based checkout, chip-based checkout, scanner-based checkout, etc., without going beyond the scope of the embodiments of the present teaching.

In some examples, at the end of the self-checkout process, the user 402 is asked to choose one of different options to receive the payment receipt, after the payment is complete. For example, the different options may include: print out the receipt, text the receipt, print out and text the receipt.

In some embodiments, after the user 402 chooses text the receipt, or print out and text the receipt, the self-checkout service 410 sends a request with the receipt related information and transaction related information to a receipt service 420, which may be implemented as a back end system of the retailer. Upon receiving the request, the receipt service 420 can gather all related information from the self-checkout service 410 and generate an electronic or digital receipt for the transaction performed by the user 402 at the physical store.

On one hand, the receipt service 420 may send an electronic message to a user device 404 of the user 402, e.g. via a communication service implemented as part of the receipt service 420 or separate from the receipt service 420. The electronic message may include a link to electronic receipt generated by the receipt service 420. On the other hand, the receipt service 420 can parse and save the receipt in a receipt database 440. The receipt service 420 can also process the receipt and associate the receipt to a customer account in a customer database 430, e.g. by linking a customer ID to a transaction code. Before obtaining an online account of the user 402, the receipt service 420 can save the receipt in association with a temporary customer account based on the receipt identity and/or a payment method voluntarily provided by the user 402.

In some embodiments, each of the customer database 430 and the receipt database 440 may be part of the database 116 or a standalone database. In some embodiments, the user device 404 may be implemented as any one of the user computing devices 110, 112, 114 of FIG. 1. The self-checkout service 410 may be implemented on a device in the store. The receipt service 420 may be implemented on the order details computing device 102, the server 104, and/or the cloud-based engine 121.

In some embodiments, after the user 402 clicks on the link in the electronic message sent to the user device 404, the user 402 is directed to an order details page on the user device 404. In some examples, the order details page may be opened in an application associated with the retailer, when the application is installed on the user device 404 and when the user device 404 is a mobile device. In some examples, the order details page may be opened as a mobile webpage associated with the retailer, when the user device 404 is a mobile device and the application is not installed on the user device 404. In some examples, the order details page may be opened as a deep webpage associated with the retailer, when the user device 404 is a desktop, laptop, or another computer type with a large screen.

To display the order details page on the user device 404, the receipt service 420 retrieves order details information related to the transaction performed by the user 402 at the physical store, from the customer database 430 and the receipt database 440. The order details information includes information of the payment receipt and some additional information related to the transaction, depending on how long time has passed from the receipt generation time or transaction complete time. The receipt service 420 then generates the order details page based on the retrieved information, and sends the order details page to the user device 404 for display. If an online account associated with the retailer is identified on the user device 404 for the user 402, the receipt service 420 can save the receipt and the order details information in association with the online account in the customer database 430 and the receipt database 440. As such, the user 402 can make use of all online functions provided by the retailer for the transaction performed at the physical store, as if the transaction was performed online.

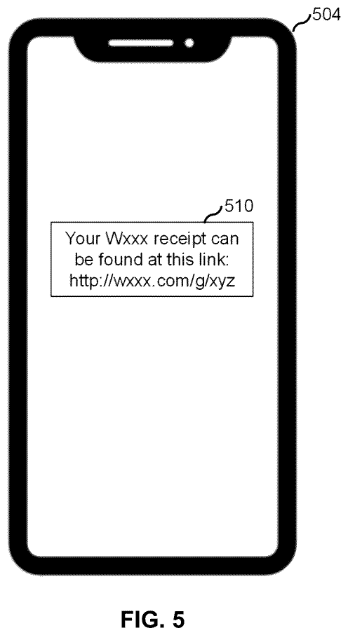

FIG. 5 illustrates an exemplary user device 504 receiving an electronic message 510 in accordance with some embodiments of the present teaching. In this example, the electronic message 510 includes a link to a payment receipt. The payment receipt may be associated with a transaction of a user of the user device 504 at a physical store of a retailer. In some embodiments, the user device 504 may be implemented as the user device 404 FIG. 4.

In some embodiments, the electronic message 510 is transmitted in response to a request, which is triggered by at least one of: a self-checkout process of the user regarding the transaction at the physical store, or a scanning of a paper copy of the payment receipt. In some examples, the request includes a phone number provided by the user; and the electronic message 510 is a text message transmitted to the user device 504 associated with the phone number. In some examples, the request includes an email address provided by the user; and the electronic message 510 is an email transmitted to the user device 504 associated with the email address.

If a user of the user device 504 clicks on the link, the user will be directed to an order details page associated with the transaction. In some embodiments, in accordance with a determination that the user has clicked on the link, a back end system of the retailer can determine whether an application associated with the retailer is installed on the user device 504. In accordance with a determination that the application is installed on the user device 504, the system can instruct the link to be opened in the application on the user device 504 for the user to view the order details page in the application. In accordance with a determination that the application is not installed on the user device, the system can instruct the link to be opened in a web browser on the user device 510 for the user to view the order details page on a website associated with the retailer.

In some embodiments, the order details page may have different formats based on: a device type of the user device 504; an operating system of the user device 504; and software used to open the link on the user device 504. In addition, the order details page may have different content items based on: a time period from when the transaction is complete to when the link is clicked on; a first time period threshold; and a second time period threshold longer than the first time period threshold.

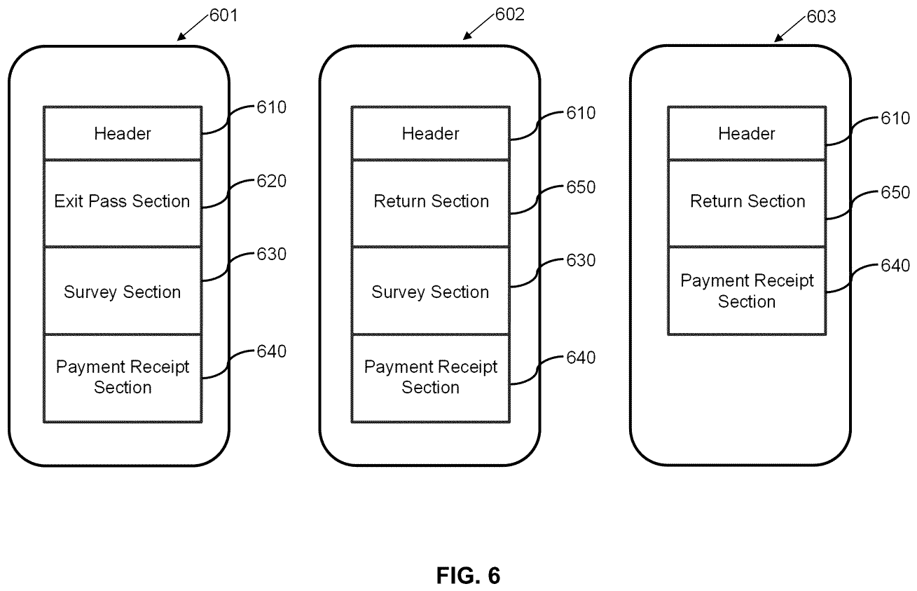

FIG. 6 illustrates various exemplary order details pages 601, 602, 603 in different scenarios, in accordance with some embodiments of the present teaching. In this example, all of the order details pages 601, 602, 603 are associated with a same transaction performed by a user in a physical store, e.g. the user of the user device 504 in FIG. 5, or the user 402 in FIG. 4. As shown in FIG. 6, the order details pages 601, 602, 603 include different content items or sections based on: the time period from when the transaction is complete to when the link is clicked on; the first time period threshold; and the second time period threshold longer than the first time period threshold.

The order details page 601 in this example is an order details page displayed to the user when the time period is shorter than the first time period threshold, e.g. shorter than 4 hours or 2 hours. As shown in FIG. 6, the order details page 601 includes: a header 610, an exit pass section 620, a survey section 630, and a payment receipt section 640.

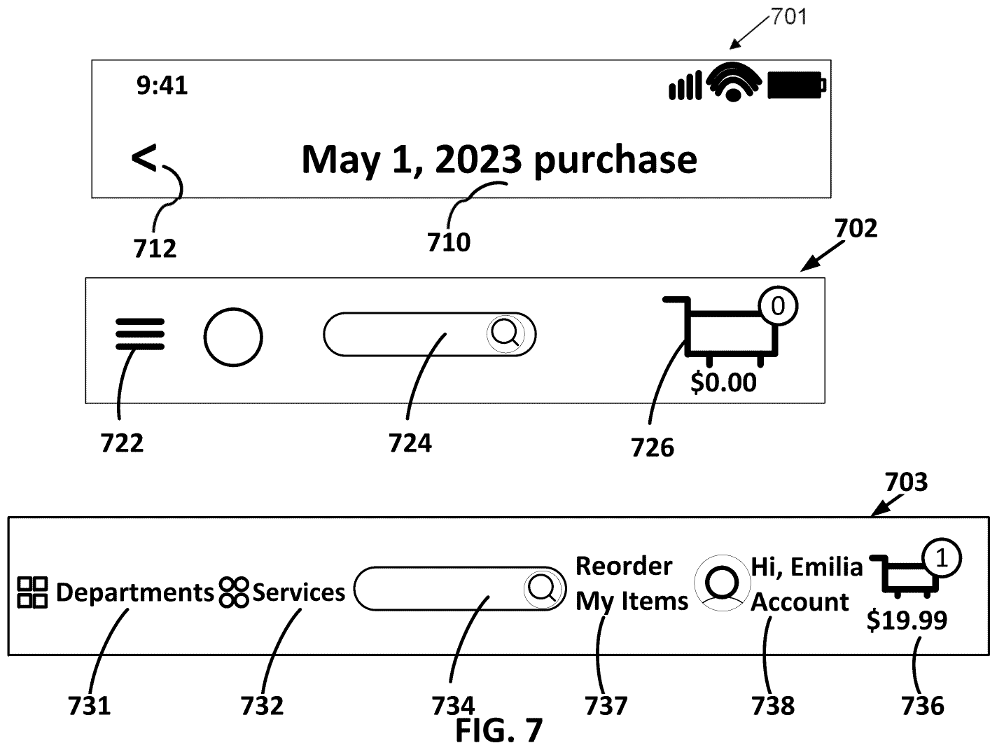

The header 610 may have different formats and include different content items based on: a device type of the user device; an operating system of the user device; and software used to open the link on the user device. FIG. 7 illustrates various exemplary headers 701, 702, 703 in an order details page, in accordance with some embodiments of the present teaching.

The header 701 in this example is a header of an order details page displayed in a retailer application on a mobile device. The header 701 includes a transaction date 710 for the transaction associated with the receipt, and an arrow 712 for the user to switch to another page.

The header 702 in this example is a header of an order details page displayed via a webpage browser on a mobile device. The header 702 includes a drop-down menu 722 for the user to choose other webpages, a search bar 724 for the user to enter a search query, and a shopping cart icon 726 indicating total quantity and total price of items in the shopping cart of the user.

The header 703 in this example is a header of an order details page displayed via a webpage browser on a desktop, laptop or another computer type with a large screen. The header 703 includes a departments icon 731 for the user to choose different departments of the retailer, a services icon 732 for the user to choose different online services provided by the retailer, a search bar 734 for the user to enter a search query, a reorder option 737 for the user to reorder previous purchased items, an account icon 738 showing an online account of the user, and a shopping cart icon 736 indicating total quantity and total price of items in the shopping cart of the user.

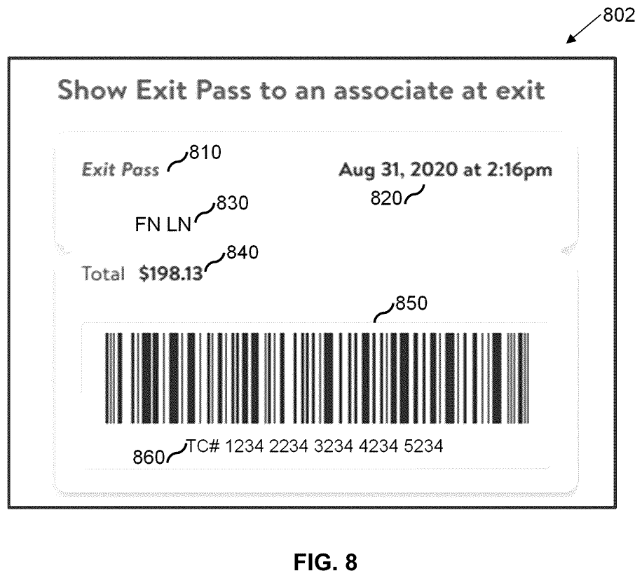

Referring back to FIG. 6, the exit pass section 620 includes information for verifying that items on the payment receipt match items exiting the physical store with the user. That is why the exit pass section 620 is displayed on the order details page 601 to the user when the time period is shorter than the first time period threshold, since the exit pass section 620 might not be useful anymore, if e.g. more than 4 hours have passed from the transaction complete time. FIG. 8 illustrates an exemplary exit pass section 802 in an order details page, e.g. the order details page 601 in FIG. 6, in accordance with some embodiments of the present teaching. As shown in FIG. 8, the exit pass section 802 includes: an exit pass icon 810, a date and time section 820 showing the date and time when the transaction is complete, an optional user name 830 of the user, an optional total price 840 of the transaction, a barcode 850 to be scanned by an associate at the physical store to verify whether items on the payment receipt match items exiting the physical store with the user, and a transaction code (TC) number 860 corresponding to the barcode 850 and identifying the transaction.

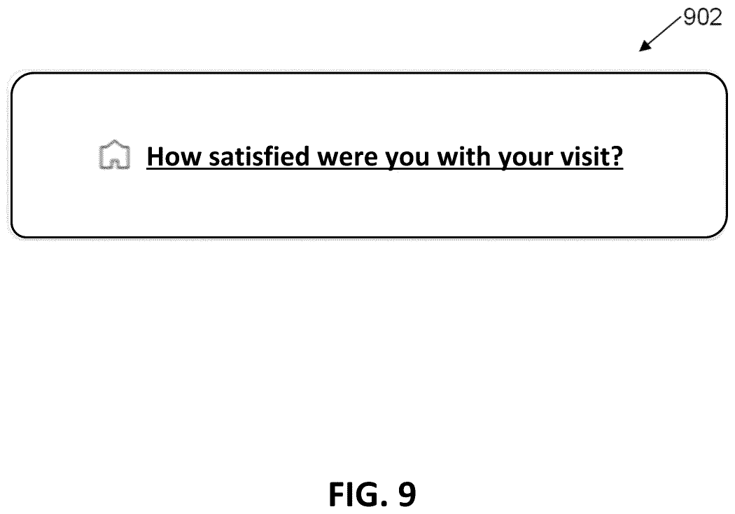

The survey section 630 in FIG. 6 may include a survey about an experience of the user at the physical store. In various embodiments, the survey may be a star rating survey or a net promoter score (NPS) survey, for understanding the customer's experience. FIG. 9 illustrates an exemplary survey section 902 in an order details page, e.g. the order details page 601 in FIG. 6, in accordance with some embodiments of the present teaching. As shown in FIG. 9, the survey section 902 includes: a survey question of “How satisfied were you with your visit?” which is associated with a hyperlink directing to more questions and/or ratings once the user clicks on the hyperlink.

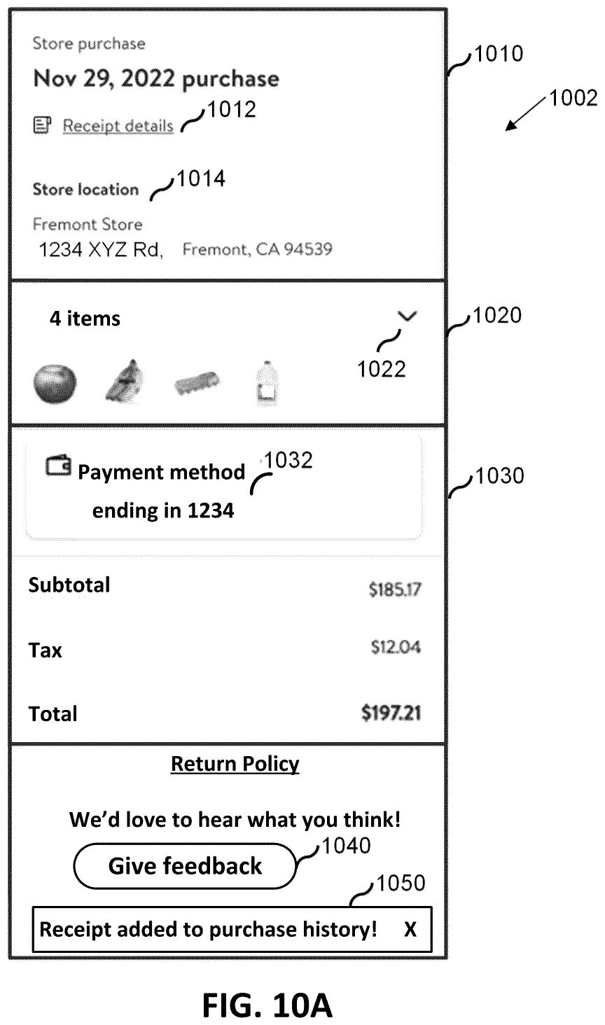

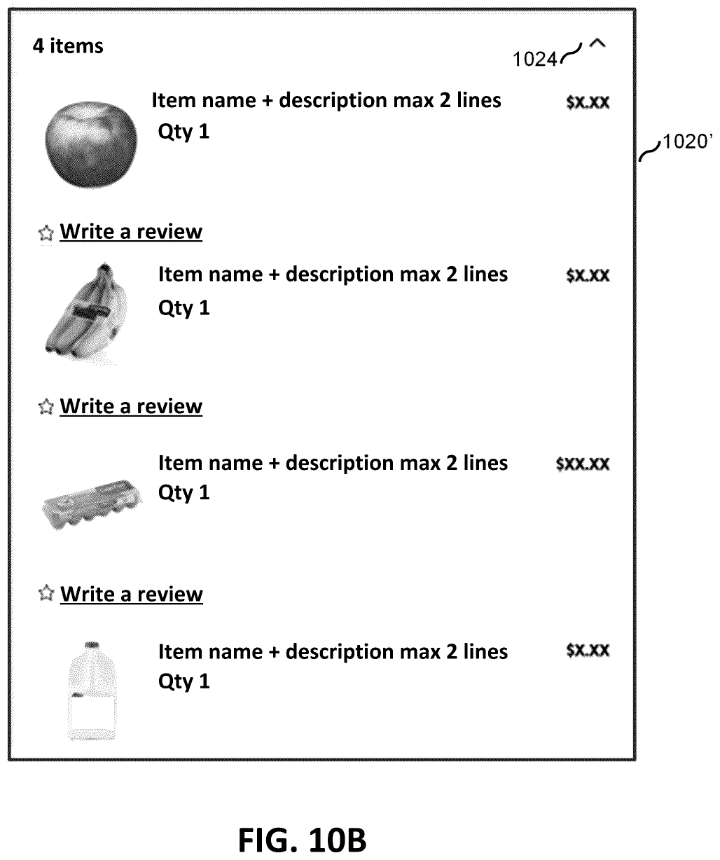

The survey section 640 in FIG. 6 may include information of the payment receipt and/or the user's transaction at the physical store. FIG. 10A illustrates an exemplary payment receipt section 1002 in an order details page, e.g. the order details page 601 in FIG. 6, in accordance with some embodiments of the present teaching. As shown in FIG. 10A, the payment receipt section 1002 includes three sub-sections: a time and place sub-section 1010, an item list sub-section 1020, and a payment sub-section 1030. The time and place sub-section 1010 includes a date of the transaction, a store location 1014 of the transaction, and a receipt details link 1012 for the user to click on to view a detailed copy, e.g. a scanned copy, of the receipt. The item list sub-section 1020 in this example includes an item list purchased via the transaction in a collapsed manner, where an expand arrow 1022 is displayed for the user to view an expanded item list. FIG. 10B illustrates an exemplary item list subsection 1020′ of a receipt section, e.g. the payment receipt section 1002 in FIG. 10A, in an order details page, in accordance with some embodiments of the present teaching. As shown in FIG. 10B, the item list subsection 1020′ includes a full list of items purchased via the transaction in an expanded manner, with detailed information like name, description, quantity, price, etc. for each item. The item list subsection 1020′ further includes a collapse arrow 1024 for the user to view the collapsed item list as shown in FIG. 10A.

In some embodiments, the item list subsection of a payment receipt section in an order details page may be displayed by default in a collapsed manner or in an expanded manner, based on: the device type of the user device; the operating system of the user device; software used to open the link on the user device; the time period from when the transaction is complete to when the link is clicked on; the first time period threshold; and the second time period threshold.

The payment sub-section 1030 in FIG. 10A includes information about: a payment method 1032 used to pay the transaction, and price information of the transaction. In the example in FIG. 10A, the payment receipt section 1002 further includes an option 1040 for the user to give feedback about the transaction to the retailer, and an indication 1050 that the receipt has been added to purchase history of the user's online account associated with the retailer, after the system has identified the online account of the user associated with the retailer, e.g. via the user's application or via the user's log-in at a website of the retailer. The system can add the user's in-store transaction as part of a purchase history associated with the online account of the user based on the payment receipt, e.g. by linking a customer ID of the online account with a TC number of the in-store transaction. As such, the purchase history associated with the online account includes both the transaction of the user at the physical store and at least one transaction of the user at an online store associated with the retailer.

Referring back to FIG. 6, the order details page 602 in this example is an order details page displayed to the user when the time period is longer than the first time period threshold but shorter than the second time period threshold, e.g. between 4 hours and 24 hours. As shown in FIG. 6, the order details page 602 includes: the header 610, a return section 650, the survey section 630, and the payment receipt section 640. While other sections have been described as in the order details page 601, the return section 650 may include a return option for the customer or user to initiate a return process associated with the transaction.

The order details page 603 in FIG. 6 is an order details page displayed to the user when the time period is longer than the second time period threshold, e.g. longer than 24 hours or 48 hours. As shown in FIG. 6, the order details page 603 includes: the header 610, the return section 650, and the payment receipt section 640.

As discussed above, many sections (e.g. the exit pass section 620, the survey section 630, the return section 650) in the order details pages 601, 602, 603 are time sensitive, and may automatically appear or disappear, depending the time period from when the transaction is complete to when the link is clicked on; the first time period threshold; and the second time period threshold longer than the first time period threshold.

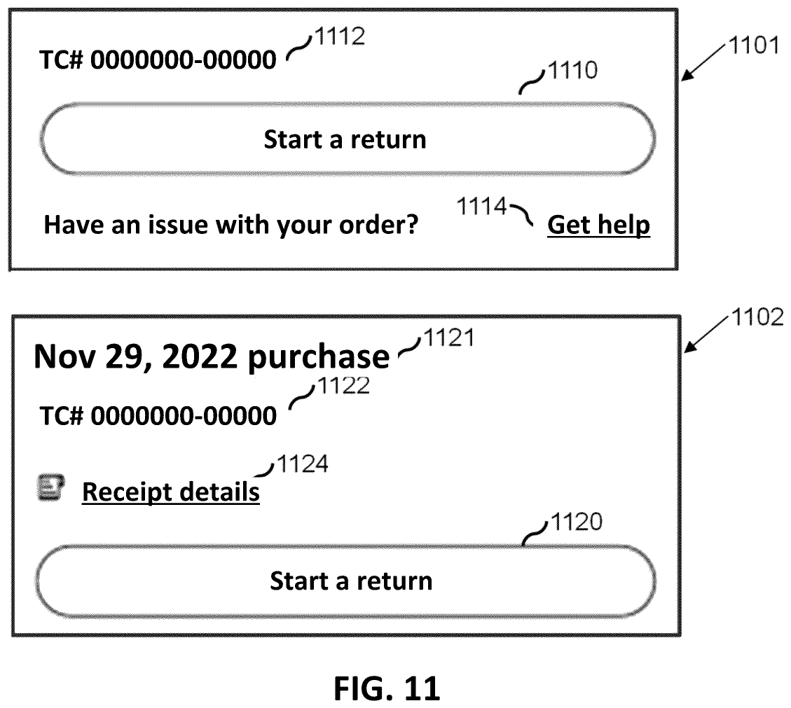

FIG. 11 illustrates various exemplary return sections 1101, 1102 in an order details page, e.g. the order details page 602 in FIG. 6, in accordance with some embodiments of the present teaching. As shown in FIG. 11, the return section 1101 includes: a TC number 1112 identifying the transaction, a button 1110 for the user to click on to start a return process associated with the transaction, and a link 1114 for the user to click on to ask for help regarding the order. Similarly, the return section 1102 includes: a date 1121 of the transaction, a TC number 1122 identifying the transaction, a button 1120 for the user to click on to start a return process associated with the transaction, and a link 1124 for the user to click on to view details of the receipt. In some embodiments, the return section 1101 is included in an order details page shown in a retailer application, while the return section 1102 is included in an order details page shown on a webpage via a web browser.

In some embodiments, in accordance with the determination that a retailer application is not installed on the user device, the system can determine whether the user has signed in an online account associated with the retailer, after the user clicks on the link in the electronic message. In accordance with a determination that the user has signed in the online account, the user is directed to the order details page with the transaction added as part of the purchase history associated with the online account. In accordance with a determination that the user has not signed in the online account, the user is directed to the order details page showing a sign-in option for the user to sign in the online account, before adding the transaction as part of the purchase history associated with the online account. In some embodiments, in accordance with a determination that the user has selected the sign-in option, the user is directed to a web page showing options for the user to either sign in or create a new online account.

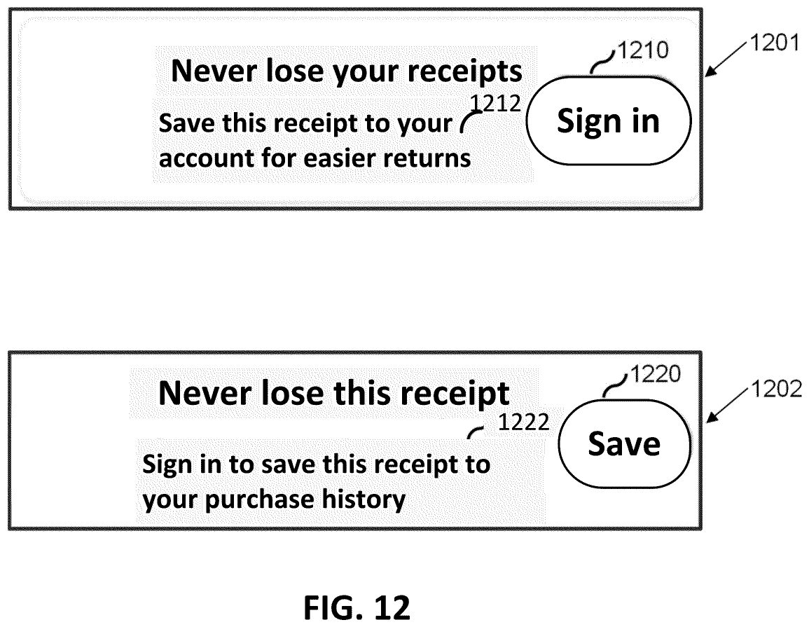

FIG. 12 illustrates various exemplary log-in sections 1201, 1202 in an order details page, e.g. one of the order details pages 601, 602, 603 in FIG. 6, in accordance with some embodiments of the present teaching. As shown in FIG. 12, the log-in section 1201 includes: a notification 1212 reciting “Save this receipt to your account for easier returns,” and a sign-in button 1210 for the user to sign in the online account to save the receipt into a purchase history of the online account. Similarly, the log-in section 1202 includes: a notification 1222 reciting “Sign in to save this receipt to your purchase history,” and a save button 1210 for the user to sign in the online account to save the receipt into the purchase history of the online account. In some embodiments, the system can compare the two log-in sections 1201, 1202 based on a total sign-in rate of users, and choose one of them having a higher sign-in rate for future order details pages.

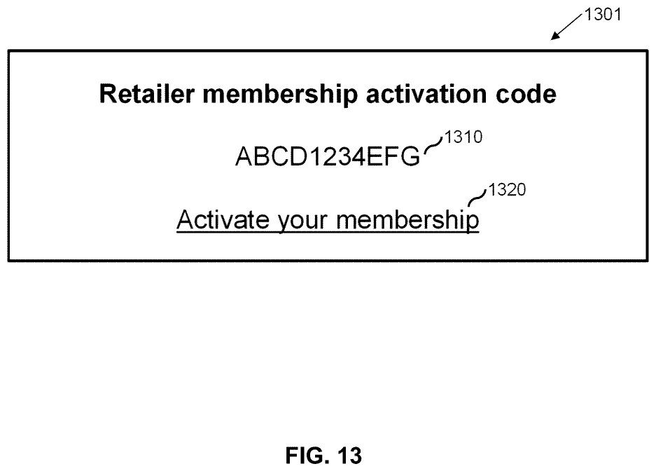

In some embodiments, an order details page may also include a user promotion section to display one or more user promotions including: an advertisement about an item and/or a discounted price, a retailer membership activation code, an account creation option, etc. FIG. 13 illustrates an exemplary user promotion section 1301 in an order details page, e.g. one of the order details pages 601, 602, 603 in FIG. 6, in accordance with some embodiments of the present teaching. As shown in FIG. 13, the user promotion section 1301 includes: a retailer membership activation code 1310, and a link 1320 for the user to click on to activate a new retailer membership. The membership may require the user to pay a fee to become a member in exchange for additional benefits related to in-store and/or online purchases.

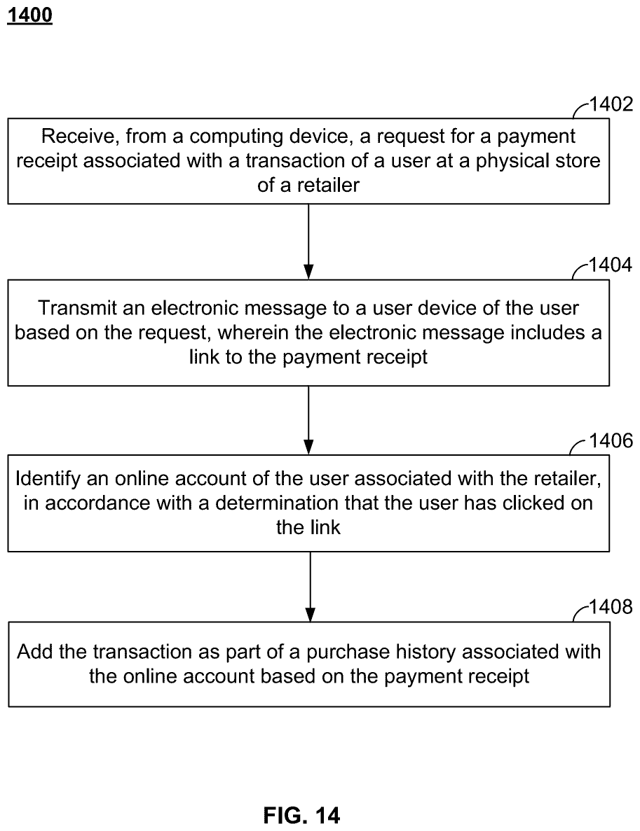

FIG. 14 shows a flowchart illustrating an exemplary method 1400 for generating and saving an in-store receipt to an online account, in accordance with some embodiments of the present teaching. In some embodiments, the method 1400 can be carried out by one or more computing devices, such as the order details computing device 102, the server 104, and/or the cloud-based engine 121 of FIG. 1. Beginning at operation 1402, a request is received from a computing device, for a payment receipt associated with a transaction of a user at a physical store of a retailer. At operation 1404, an electronic message is transmitted to a user device of the user based on the request. The electronic message includes a link to the payment receipt. At operation 1406, an online account of the user associated with the retailer is identified, in accordance with a determination that the user has clicked on the link. The transaction is added at operation 1408 as part of a purchase history associated with the online account based on the payment receipt.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

1. A system, comprising:
a processor;
a non-transitory memory storing instructions
that when executed, cause the processor to:
receive, from a computing device, a request for a receipt associated with a transaction of a user at a first physical location;
transmit an electronic message to a user device of the user based on the request, wherein the electronic message includes a link to the receipt;
identify an online account of the user, in accordance with a determination that the user has clicked on the link, f
add the transaction as part of a history log associated with the online account based on the receipt by linking a transaction code of the transaction with an identifier of the online account in a user database; and
transmit for display the receipt on a graphical user interface of the user device of the user, wherein the graphical user interface displays user interface elements associated with the online account of the user.

2. The system of claim 1, wherein the request is triggered by at least one of:
a self-checkout process of the user regarding the transaction at the first physical location; or
a scanning of a paper copy of the receipt.

3. The system of claim 2, wherein:
the request includes a phone number provided by the user; and
the electronic message is a text message transmitted to the user device associated with the phone number.

4. The system of claim 2, wherein:
the request includes an email address provided by the user; and
the electronic message is an email transmitted to the user device associated with the email address.

5. The system of claim 1, wherein the instructions when executed, further cause the processor to:
in accordance with the determination that the user has clicked on the link, determine whether an application is installed on the user device;
in accordance with a determination that the application is installed on the user device, open the link in the application on the user device for the user to view an order details page associated with the transaction in the application; and
in accordance with a determination that the application is not installed on the user device, open the link in a web browser on the user device for the user to view the order details page associated with the transaction on a website.

6. The system of claim 5, wherein the order details page has different formats based on:
a device type of the user device;
an operating system of the user device; and
software used to open the link on the user device.

7. The system of claim 5, wherein the order details page has different content items based on:
a time period from when the transaction is complete to when the link is clicked on;
a first time period threshold; and
a second time period threshold longer than the first time period threshold.

8. The system of claim 7, wherein the order details page comprises information of the receipt and at least one of:
an exit pass section including a barcode to be scanned by an associate at the first physical location to verify whether items on the receipt match items exiting the first physical location with the user;
a survey section including a survey about an experience of the user at the first physical location; or
a return section including a return option for the user to initiate a return process associated with the transaction.

9. The system of claim 8, wherein when the time period is shorter than the first time period threshold, the order details page includes:
information of the receipt in an expanded manner;
the exit pass section; and
the survey section.

10. The system of claim 8, wherein when the time period is longer than the first time period threshold but shorter than the second time period threshold, the order details page includes:
information of the receipt in a collapsed manner;
the survey section; and
the return section.

11. The system of claim 8, wherein when the time period is longer than the second time period threshold, the order details page includes:
information of the receipt in a collapsed manner; and
the return section.

12. The system of claim 5, wherein the instructions when executed, further cause the processor to:
in accordance with the determination that the application is not installed on the user device, determine whether the user has signed in the online account;
in accordance with a determination that the user has signed in the online account, direct the user to the order details page with the transaction added as part of the history log associated with the online account; and
in accordance with a determination that the user has not signed in the online account, direct the user to the order details page showing a sign-in option for the user to sign in the online account, before adding the transaction as part of the history log associated with the online account.

13. The system of claim 12, wherein the instructions when executed, further cause the processor to:
in accordance with a determination that the user has selected the sign-in option, direct the user to a web page showing options for the user to either sign in or create a new online account.

14. The system of claim 1, wherein the history log associated with the online account includes both the transaction of the user at the first physical location and at least one transaction of the user at an online store.

15. A computer-implemented method, comprising:
receiving, from a computing device, a request for a receipt associated with a transaction of a user at a first physical location;
transmitting an electronic message to a user device of the user based on the request, wherein the electronic message includes a link to the receipt;
identifying an online account of the user, in accordance with a determination that the user has clicked on the link;
adding the transaction as part of a history log associated with the online account based on the receipt by linking a transaction code of the transaction with an identifier of the online account in a user database; and
transmitting for display the receipt on a graphical user interface of the user device of the user, wherein the graphical user interface displays user interface elements associated with the online account of the user.

16. The computer-implemented method of claim 15, further comprising:
in accordance with the determination that the user has clicked on the link, determining whether an application is installed on the user device;
in accordance with a determination that the application is installed on the user device, opening the link in the application on the user device for the user to view an order details page associated with the transaction in the application; and
in accordance with a determination that the application is not installed on the user device, opening the link in a web browser on the user device for the user to view the order details page associated with the transaction on a website.

17. The computer-implemented method of claim 16, wherein the order details page has different content items based on:
a time period from when the transaction is complete to when the link is clicked on;
a first time period threshold; and
a second time period threshold longer than the first time period threshold.

18. The computer-implemented method of claim 17, wherein the order details page comprises information of the receipt and at least one of:
an exit pass section including a barcode to be scanned by an associate at the first physical location to verify whether items on the receipt match items exiting the first physical location with the user;
a survey section including a survey about an experience of the user at the first physical location-store; or
a return section including a return option for the user to initiate a return process associated with the transaction.

19. The computer-implemented method of claim 18, further comprising:
in accordance with the determination that the application is not installed on the user device, determining whether the user has signed in the online account;
in accordance with a determination that the user has signed in the online account, directing the user to the order details page with the transaction added as part of the purchase history log associated with the online account; and
in accordance with a determination that the user has not signed in the online account, directing the user to the order details page showing a sign-in option for the user to sign in the online account or create a new online account, before adding the transaction as part of the history log associated with the online account.

20. A non-transitory computer readable medium having instructions stored thereon, wherein the instructions, when executed by at least one processor, cause at least one device to perform operations comprising:
receiving, from a computing device, a request for a payment receipt associated with a transaction of a user at a first physical location;
transmitting an electronic message to a user device of the user based on the request, wherein the electronic message includes a link to the payment receipt;
identifying an online account of the user, in accordance with a determination that the user has clicked on the link;
adding the transaction as part of a history log associated with the online account based on the payment receipt by linking a transaction code of the transaction with an identifier of the online account in a user database; and
transmitting for display the receipt on a graphical user interface of the user device of the user, wherein the graphical user interface displays user interface elements associated with the online account of the user.
